(19) United States
(12) Patent Application Publication
(10) Pub. No.: US 2002/0171838 A1
(43) Pub. Date: Nov. 21, 2002

(54) Variable sampling control for rendering pixelization of analysis results in a bio-disc assembly and apparatus relating thereto

(76) Inventors: Andrew Attila Pal, Rancho Santa Margarita, CA (US); Mark Oscar Worthington, Irvine, CA (US)

Correspondence Address: John Harriman II, COUDERT BROTHERS, LLP, Twenty-Third Floor, 333 South Hope Street, Los Angeles, CA, 90071, US

(21) Appl. No.: 10/150,575

(22) Filed: May 16, 2002

Related U.S. Application Data
(60) Provisional application No. 60/291,233, filed on May 16, 2001.

(51) Int. Cl. G01N 21/00

(52) U.S. Cl. 356/436

(57) ABSTRACT

Methods and apparatus for effective investigational feature recognition in laboratory samples in optical equipment. Pixelization permits investigational feature recognition at the digitized waveform level instead of at the image level. Pixelization can be used with a bio-disc and its related disc drive assembles. The analog signal from the drive's detector is sampled into a digital waveform. Patterns in the waveform that match the features in the laboratory samples are counted. Synchronizing the sampling rate with the bio-disc drive clock cycle is provided. Other embodiments include calibrating the sampling rate using wobble grooves, pit fields, and an external sampling card with its associated counting software.

### CROSS-REFERENCE TO RELATED APPLICATIONS

The present application claims the benefit of priority from U.S. Provisional Patent Application Serial No. 60/291,233 filed on May 16, 2001.

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

This invention relates in general to sampling methods and signal processing and, in particular, to imaging of investigational features or signal elements associated with testing biological, chemical, or biochemical samples. More specifically, but without restriction to the particular embodiments hereinafter described in accordance with the best mode of practice, this invention relates to methods and apparatus for setting optimal sampling rates during the operation of cell counting using bio-discs and related optical disc drive assembles.

2. Discussion of the Related Art

A number of research and diagnostic situations require isolation and analysis of specific cells from a mixture of cells. Particularly the source could be blood, spinal fluid, bone marrow, tumor homogenates, lymphoid tissue, and the like. For example, blood cell counts are used during diagnosis, treatment and follow-up to determine the health of a patient. Blood count is the enumeration of the red corpuscles and the leukocytes (white blood cell or WBC) per cubic mm of whole blood. Often other material or reporters such as beads, which are small plastic or magnetic particles used for DNA analysis, are also counted for analytical purposes. In some instances, the beads contain complimentary DNA strands that can bind to target DNA strands (strand sequences to be studied). Locking down the target strands to the much larger beads will help analysis of DNA strands that may be too small to identify. In other settings, complimentary proteins are put on beads to capture the target proteins.

Optical imaging is a widely acknowledged technique for detecting minute differences between dynamic images. Although light in the visible and near IR region is not very absorbing, it is highly scattering in biological tissues. Thus, various techniques have been employed to extract optical information of a biological sample that has diagnostic value. When an unstained cell is struck by light in the visible region or laser beam, the scattered light spreads out in all directions. Using a detector, scattered light is collected to obtain information about cellular granularity and cell surface structure. This specific property of light scattering is a promising tool for classifying WBCs and reticulocyte sub-populations in blood samples. Imaging based on light scattering signal yields high-resolution, two-dimensional images. It is also possible to obtain three-dimensional imaging with near infrared light.

In prior optical imaging systems for cells and other biological matter, the image is often produced by sampling at high frequency the analog signals generated by the detector as it collects electromagnetic light beams that have been scattered or reflected by the laboratory samples. One reason for the high sampling rate is that the high resolution images are needed for the purpose of recognizing and counting investigational features. An investigational feature is a generic term used herein that denotes any countable matter such as a cell, a bead, and any other object found in laboratory samples. The high sampling rate, needed to produce the high resolution images, requires expensive system resources and lowers the rate at which assays can be conducted. Furthermore, processor-intensive mathematical transforms have to be performed on the images before investigational features can be recognized. Performing data manipulation, transfer, and mathematical recognition at high sampling rates require expensive system resources in both hardware and software.

### SUMMARY OF THE INVENTION

The present invention relates in general to sampling methods and signal processing, and in particular, to imaging of investigational features or signal elements associated with testing biological, chemical, or bio-chemical samples. More specifically, but without restriction to the particular embodiments hereinafter described in accordance with the best mode of practice, this invention relates to methods for sampling bead fields on a bio-disc using relative pixelization. This invention is further directed to optical bio-discs and drives relating thereto as used in conjunction with the sampling methods described herein. Software embodying the methods according to the present invention is also provided.

The present invention is also directed to bio-discs, bio-drives, and related methods. This invention or different aspects thereof may be readily implemented in, adapted to, or employed in combination with the discs, assays, and systems disclosed in the following commonly assigned and co-pending patent applications: U.S. patent application Ser. No. 09/378,878 entitled “Methods and Apparatus for Analyzing Operational and Non-operational Data Acquired from Optical Discs” filed Aug. 23, 1999; U.S. Provisional Patent Application Serial No. 60/150,288 entitled “Methods and Apparatus for Optical Disc Data Acquisition Using Physical Synchronization Markers” filed Aug. 23, 1999; U.S. patent application Ser. No. 09/421,870 entitled “Trackable Optical Discs with Concurrently Readable Analyte Material” filed Oct. 26, 1999; U.S. patent application Ser. No. 09/643,106 entitled “Methods and Apparatus for Optical Disc Data Acquisition Using Physical Synchronization Markers” filed Aug. 21, 2000; U.S. patent application Ser. No. 09/999,274 entitled “Optical Bio-discs with Reflective Layers” filed Nov. 15, 2001; U.S. patent application Ser. No. 09/988,728 entitled “Methods And Apparatus For Detecting And Quantifying Lymphocytes With Optical Biodiscs” filed Nov. 20, 2001; U.S. patent application Ser. No. 09/988,850 entitled “Methods and Apparatus for Blood Typing with Optical Bio-discs” filed Nov. 19, 2001; U.S. patent application Ser. No. 09/989,684 entitled “Apparatus and Methods for Separating Agglutinants and Disperse Particles” filed Nov. 20, 2001; U.S. patent application Ser. No. 09/997,741 entitled “Dual Bead Assays Including Optical Biodiscs and Methods Relating Thereto” filed Nov. 27, 2001; U.S. patent application Ser. No. 09/997,895 entitled “Apparatus and Methods for Separating Components of Particulate Suspension” filed Nov. 30, 2001; U.S. patent application Ser. No. 10/005,313 entitled “Optical Discs for Measuring Analytes” filed Dec. 7, 2001; U.S. patent application Ser. No. 10/006,371 entitled “Methods for Detecting Analytes Using Optical Discs and Optical Disc Readers” filed Dec. 10, 2001; U.S. patent application Serial No. 10/006,620 entitled “Multiple Data Layer Optical Discs for Detecting Analytes” filed Dec. 10, 2001; U.S. patent application Ser. No. 10/006,619 entitled “Optical Disc Assemblies for Performing Assays” filed Dec. 10, 2001; U.S. patent application Ser. No. 10/020,140 entitled “Detection System For Disk-Based Laboratory And Improved Optical Bio-Disc Including Same” filed Dec. 14, 2001; U.S. patent application Ser. No. 10/035,836 entitled “Surface Assembly For Immobilizing DNA Capture Probes And Bead-Based Assay Including Optical Bio-Discs And Methods Relating Thereto” filed Dec. 21, 2001; U.S. patent application Ser. No. 10/038,297 entitled “Dual Bead Assays Including Covalent Linkages For Improved Specificity And Related Optical Analysis Discs” filed Jan. 4, 2002; U.S. patent application Ser. No. 10/043,688 entitled “Optical Disc Analysis System Including Related Methods For Biological and Medical Imaging” filed Jan. 10, 2002; and U.S. Provisional Application Serial No. 60/348,767 entitled “Optical Disc Analysis System Including Related Signal Processing Methods and Software” filed Jan. 14, 2002. All of these applications are herein incorporated by reference in their entireties. They thus provide background and related disclosure as support hereof as if fully repeated herein.

One embodiment of the present invention presents a scheme for sampling signals to allow for fast recognition of investigational features in laboratory samples. The specially sampled signals allow for faster counting of investigational features with less hardware and software overhead. One embodiment of the present invention is a method called “pixelization”. Pixelization reduces the need to use high resolution images and associated high sampling rates for recognition. Pixelization permits recognition of investigational features to be conducted at the digitized waveform level instead of at the image level. Thus, instead of using mathematical transform functions on high resolution images to recognize investigational features, the analog-to-digital sampling rate can be adjusted so that certain investigational features will be recognizable in the digital waveform signals.

Another embodiment of the present invention uses pixelization in conjunction with a bio-disc and its related disc drive assembles. A bio-disc is a modified disc, such as, for example, a CD, CD-R, or DVD optical disc that contains special mechanisms for housing laboratory samples. The related disc drive is a player, such as, for example, a modified CD, CD-R, or DVD player, that rotates the optical bio-disc, directs laser light at the disc and detects light that has interacted with the sample on the disc. More specifically, when the bio-disc is inserted in the disc drive, the disc is rotated to allow for mixing or centrifugation of the laboratory samples. Electromagnetic laser light is directed at the samples on disc. Scattered or reflected light is detected by a detector that generates an analog signal. Using the principles of pixelization, the analog signal is sampled and transformed into a digital waveform and patterns in the waveform are recognized as corresponding to investigational features in the samples and then counted. Another embodiment of the present invention is software that performs the counting and displays results to the end user.

In yet another embodiment of the present invention, there is provided a method of calculating the desired sampling rate for the pixelization method. Given the rotation speed of the disc and the expected size of the investigational feature, the method calculates the sampling rate needed to achieve the effect of pixelization.

Another embodiment hereof is directed to a method of synchronizing the desired sampling rate with the clock cycle of the optical disc player. The sampling rate is adjusted to create digital waveform patterns that span multiples of the optical disc player clock cycle. In this manner, the digitized waveform signal can be electrically reproduced into the optical disc clock cycles. The digitized waveform signal can be sliced and sampled directly into an optical disc decoding circuit. Then, a Channel Bit Data signal of the optical player can be used to store the information representing the presence of investigational features.

Other embodiments of the present invention are directed at calibrating the sampling rate of an analog signal. Wobble grooves on the CD-R based embodiment of the optical bio-disc may be used for calibration. In a specific embodiment, the sampling rate is controlled by the pit fields on a CD based optical disc. In another implementation, an external sampling card is used to control the sampling process.

More specifically, the present invention is directed to a method of identifying an investigational feature imaged by an optical system. This method includes the steps of preparing the investigational feature, directing an incident beam of electromagnetic radiation at the investigational feature, allowing the incident beam of electromagnetic radiation to interact with the investigational feature to thereby create a modified beam of electromagnetic radiation that includes characteristics related to the investigational feature, detecting the modified beam of electromagnetic radiation after interaction with the investigational feature to form a return signal, and sampling the return signal by reducing the number of samples used to sample the return signal in order to generate a lowest possible number of signal points necessary to identify the investigational feature.

According to another aspect of the present invention, there is provided an optical system for identifying an investigational feature. The system includes a rotateable disc capable of housing a laboratory sample containing at least one investigational feature and an optical disc drive. The optical disc drive generates an incident beam of electromagnetic radiation that is directed at the investigational feature. The incident beam is allowed to interact with the investigational feature to thereby create a modified beam of electromagnetic radiation that includes characteristics related to the investigational feature. In this manner, a detector may detect the modified beam of electromagnetic radiation after interaction with the investigational feature to form a return signal. The system further includes sampling means for sampling the return signal in a manner that reduces the number of samples used to sample the return signal to thereby generate the lowest possible number of signal points necessary to identify the investigational feature.

In accordance with yet another aspect of this invention, there is further provided a method of identifying an investigational object associated with a rotatable disc. This method includes the steps of rotating a respective disc including at least one investigational object, directing an incident beam of electromagnetic radiation toward the respective disc, allowing the incident beam of electromagnetic radiation to interact with the investigational object to thereby create a modified beam of electromagnetic radiation that includes characteristics related to the investigational object, detecting the modified beam of electromagnetic radiation after interaction with the investigational object to form a return signal, and sampling the return signal in a predetermined manner to thereby identify the investigational object. The present invention is further directed to filtering aspects that remove from a detected and processed analog signal, any perturbations associated with features not requiring identification or counting to properly perform a particular assay of interest.

### BRIEF DESCRIPTION OF THE DRAWING

Further objects, aspects, and methods of the present invention together with additional features contributing thereto and advantages accruing therefrom will be apparent from the following description of the preferred embodiments of the invention which are shown in the accompanying, wherein:

FIG. 1 is a pictorial representation of a bio-disc system according to the present invention;

FIG. 2 is a detailed pictorial representation of the interior of a bio-disc player assembly according to an embodiment of the present invention;

FIG. 3A is a pictorial representation of a pixilated image of a cell and surrounding disc area;

FIG. 3B presents an isolated pixilated image of the cell of FIG. 3A and a related graphical illustration that shows the detected analog signal corresponding to the imaged cell;

FIG. 3C is a view similar to FIG. 3B showing an expanded pixilated area and corresponding discretized signals according to the present invention;

FIG. 3D is a view similar to FIG. 3C illustrating the optimized pixelated image field and related digital IDs;

FIG. 3E is a graphical representation of a proximally positioned white blood cell approximately 10.0 μm in diameter positioned relative to the tracks of an optical bio-disc according to the present invention;

FIG. 3F is a series of analog signature traces derived from the white blood cell of FIG. 3E;

FIG. 3G is a series of optimized digital IDs corresponding to the analog signals shown in FIG. 3F;

FIG. 4 is a pictorial representation of the signal when an investigational feature is sampled at 8 MHz;

FIG. 5 is a pictorial representation of the signal when an investigational feature is sampled at 1 MHz;

FIG. 6 is a pictorial representation of the signal when an investigational feature is sampled at 0.7 MHz;

FIG. 7 illustrates how the signal synchronizes with the CD Clock Cycle according to an embodiment of the present invention;

FIG. 8A illustrates how the efficiency of the signal is related to how closely it matches to the multiples of the CD Clock Cycle;

FIG. 8B illustrates the logical state transition map of the recognition system according to an embodiment of the present invention;

FIG. 9 is a pictorial elevation view depicting the calibration area of a disc according to an embodiment of the present invention;

FIG. 10 is flow chart illustrating a method of using an embodiment of the present invention to count investigational features on a bio-disc;

FIG. 11A is a flow chart depicting a method of determining the sampling rate according to an embodiment of the present invention;

FIG. 11B is a flow chart providing further detail of the method represented in FIG. 11A;

FIG. 11C is a flow chart that provides further details of the method shown in FIG. 11A;

FIG. 12 is a pictorial elevation view depicting a representative bead for the purpose of illustrating the method of determining the sampling rate according to an embodiment of the present invention;

FIG. 13 is a view similar to FIG. 12 depicting a representative red blood cell for the purpose of illustrating the method of determining the sampling rate according to an embodiment of the present invention;

FIG. 14 is a screen-shot representation showing the release notes of BCDTM Capture Studio software that is used in accordance with an embodiment of the present invention;

FIGS. 15A and 15B are example screen-shot representations illustrating the diagnostic test selection menu including the different type of assays that can be performed by employing software that uses the methods of the present invention;

FIG. 16 is a screen-shot representation of the counting software output at the beginning of the counting operation;

FIG. 17 illustrates the monitor output of the counting software at the conclusion of the counting operation; and

FIG. 18 illustrates the use of beads as a calibration mechanism according to another aspect of the present invention.

### DETAILED DESCRIPTION OF THE INVENTION

The present invention is directed to methods and apparatus for effective recognition of cellular matter in laboratory samples using optical equipment. An embodiment of the present invention presents a scheme of sampling signals to allow for fast recognition of investigational features in laboratory samples. In the following description, numerous specific details are set forth to provide a more thorough description of embodiments of the invention. It would be apparent, however, to those skilled in the art, that the invention may be practiced without these specific details. In other instances, well known features have not been described in detail so as not to obscure the invention.

The present invention may be readily applied to recognizing any type of cellular matter. This can include, but is not limited to, red blood cells, white blood cells, reporters such as beads and any other objects, both biological and non-biological, that produce similar optical signatures that can be detected by an optical reader.

System Apparatus

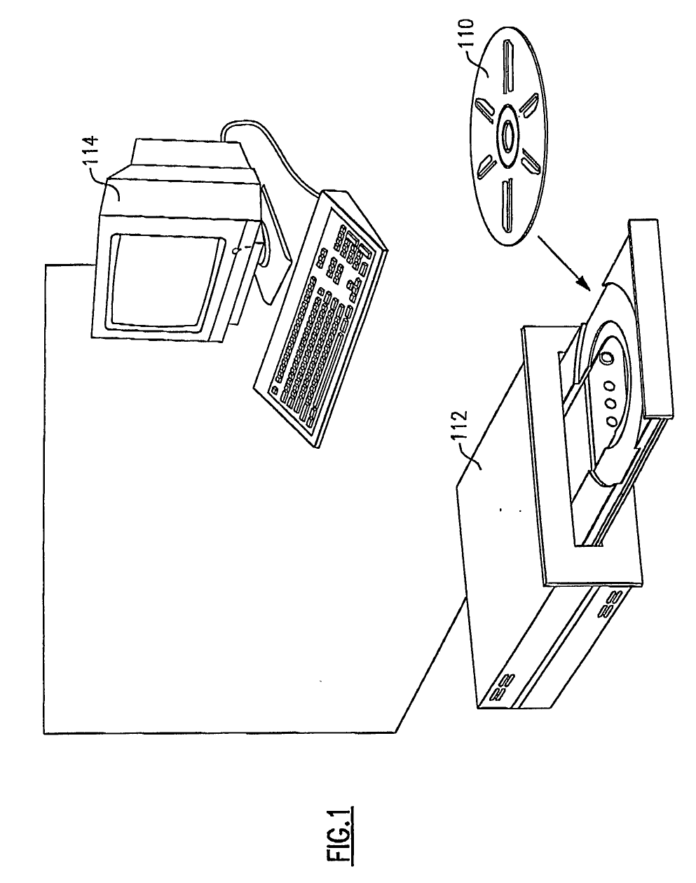

Embodiments of the present invention involve the retrieval of optical imaging data from cellular matter in laboratory samples. FIG. 1 is a perspective view of a bio-disc 110 according to the present invention. The present optical bio-disc 110 is shown in conjunction with an optical disc drive 112 and a display monitor 114. Test samples are deposited onto designated areas on bio-disc 110. Once the bio-disc is inserted into optical disc drive 112, the disc drive is responsible for collecting information from the sample through the use of electromagnetic radiation beams that have been modified or modulated by interaction with the laboratory samples. After the information is analyzed and processed, computer monitor 114 displays the results. More specifically, once the samples are deposited into designated fluid channels of the optical bio-disc, the bio-disc is inserted in a bio-disc drive. The disc is spun inside the drive and cells in the samples are chemically captured in place by antigens that have been deposited into the fluid channels during the manufacturing process of the disc. The location of capture is called a capture zone and it is also where a beam of electromagnetic energy generated inside the drive will interact with the samples.

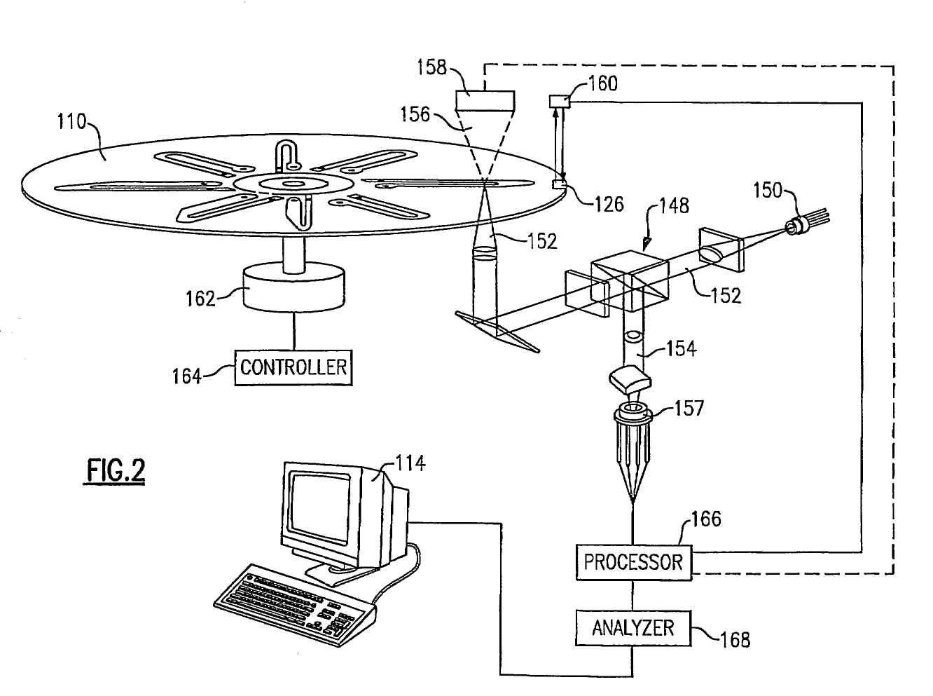

With reference next to FIG. 2, there is presented a diagram illustrating the operation of the interior of the optical disc drive. FIG. 2 shows an optical assembly 148, a light source 150 that produces the incident or interrogation beam 152, a return beam 154, and a transmitted beam 156. In the case of the reflective type of bio-disc, the return beam 154 is reflected from the reflective surface bio-disc 110. The reflective bio-disc reflects all light that is directed onto the disc. In the reflective optical bio-disc 110, the return beam 154 is detected and analyzed for the presence of signal agents by a bottom detector 157. Such reflective bio-discs are described in further detail in, for example, the above referenced and incorporated U.S. patent application Ser. No. 09/999,274. In the transmissive bio-disc embodiment, a portion of the light directed at the disc is allowed to pass through the disc. Besides using a reflective disc, the present invention also uses a transmissive bio-disc embodiment, wherein transmitted beam 156 is detected by a top detector 158 and is also analyzed for the presence of signal agents. In the transmissive embodiment, a photo detector may be used as a top detector 158. This type of transmissive bio-disc is discussed in further detail in, for example, the above referenced and incorporated U.S. patent application Ser. Nos. 10/005,313; 10/006,371; 10/006,620; and 10/043,688.

FIG. 2 also shows a hardware trigger mechanism that includes the trigger markings 126 on the disc and a trigger detector 160. The hardware triggering mechanism is used in both reflective bio-discs and transmissive bio-discs. The triggering mechanism allows the processor 166 to collect data only when the interrogation beam 152 is on a capture zone 140. In the transmissive bio-disc system, a software trigger may also be used. The software trigger uses the bottom detector to signal the processor 166 to collect data as soon as the interrogation beam 152 hits the edge of a capture zone. FIG. 2 also illustrates a drive motor 162 and a controller 164 for controlling the rotation of the optical bio-disc 110. FIG. 2 further shows the processor 166 and analyzer 168 implemented in the alternative for processing the return beam 154 and transmitted beam 156 associated the transmissive optical bio-disc. In the case of the transmissive optical bio-disc, the transmitted beam 156 carries the information about the biological sample. In this embodiment, there is pre-recorded information on the disc. Detector 158 collects the beam. The detector then sends the detected beam intensity as an analog signal to a signal processor 166 where the analog signal is sampled at discrete time intervals and a digital reproduction is created. The sampling rate determines the number of times a digitized signal is taken from an analog signal. Further aspects relating to these imaging methods and techniques are discussed in the above referenced and incorporated U.S. patent application Ser. No. 10/043,688.

Disc Implementation

A bio-disc is similar in structure to the CD, CD-R, CD-RW, DVD, or equivalent discs that are widely available in the market today. Like these commonly available embodiments, each bio-disc has tracks that wind around the center of the disc from the interior edge to the exterior edge. Each track is defined by either a wobble groove or pits and lands, where pits are depressed areas along the track and lands are the areas that are not depressed. The wobble groove or the combination of pits and lands, alters the way the incident laser beam is reflected as it moves along the track. The change in reflectivity results in the signal pattern generated by the reflected beam which in turn represents encoded data. In addition to having these common disc features, the bio-disc also has fluidic channels to house laboratory samples and necessary chemical solutions, triggering mechanisms to initiate the reading of samples, and other features designed for conducting biological analysis. The bio-disc may include encoded information for performing, controlling, and post-processing the test or assay. For example, such encoded information may be directed to controlling the rotation rate of the disc. Depending on the test, assay, or investigational protocol, the rotation rate may be variable with intervening or consecutive sessions of acceleration, constant speed, deceleration, or reverse rotation. These sessions may be closely controlled both as to speed and time of rotation to provide, for example, mixing, agitation, or separation of fluids and suspensions with agents, reagents or antibodies. The methods of the present invention may thus be advantageously implemented on such modified optical discs or bio-discs.

Drive Implementation

A bio-disc drive assembly may be employed to rotate the disc, read and process any encoded information stored on the disc, and analyze the DNA or other samples in the flow channel of the bio-disc. The bio-disc drive is thus provided with a motor for rotating the bio-disc, a controller for controlling the rate of rotation of the disc, a processor for processing return signals form the disc, and an analyzer for analyzing the processed signals. The rotation rate of the motor is controlled to achieve the desired rotation of the disc. The bio-disc drive assembly may also be utilized to write information to the bio-disc either before, during, or after the test samples in the flow channels and target zones are interrogated by the read beam of the drive and analyzed by the analyzer. The bio-disc may include encoded information for controlling the rotation rate of the disc, providing processing information specific to the type of DNA test to be conducted, and for displaying the results on a monitor associated with the drive in accordance with the processing methods of this invention.

Recognition of Investigational Features and Pixelization

In the following disclosure, an example of a DNA based assay using a bio-disc is shown to illustrate the methods of the present invention. This is by way of example only and the present invention has equal application to other assays as well. A DNA based assay includes attachment of micro-particles or reporter beads to the disc surface as a detection method. These particles or beads are selected in size so that the read or interrogation beam of a disc drive or reader can “see” or detect a change of surface reflectivity caused by the particles. Identification of the beads and related sampling methods are implemented with the bio-discs as indicated below.

Sampling rate or frequency can be adjusted to provide a square pulse response from a feature of a specific size. A pixel can be used to identify a bead, cell, or other signal element. The sampling rate is reduced until a pixel represents the physical dimension of the element or feature under investigation. The pixel is a visual element as displayed on a screen after mathematical manipulation of a signal pulse as received from a drive and given a value through analog to digital conversion.

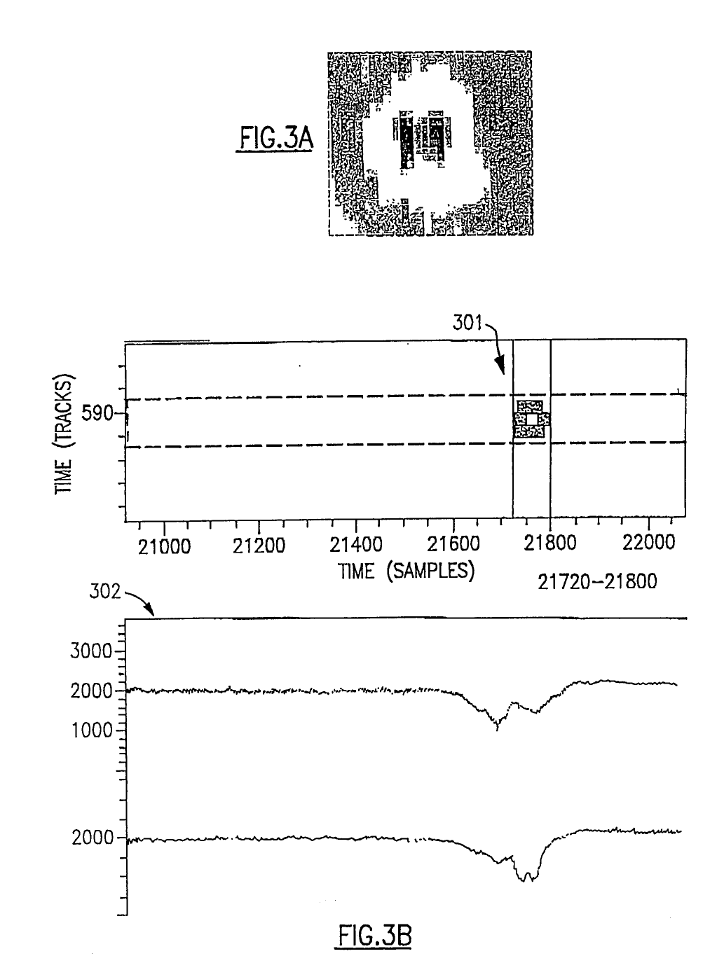

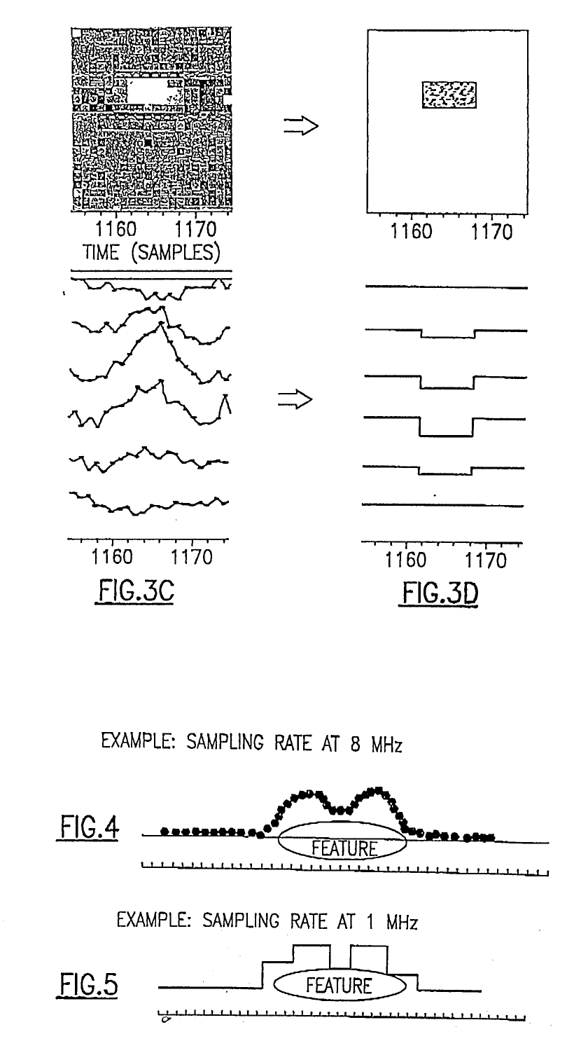

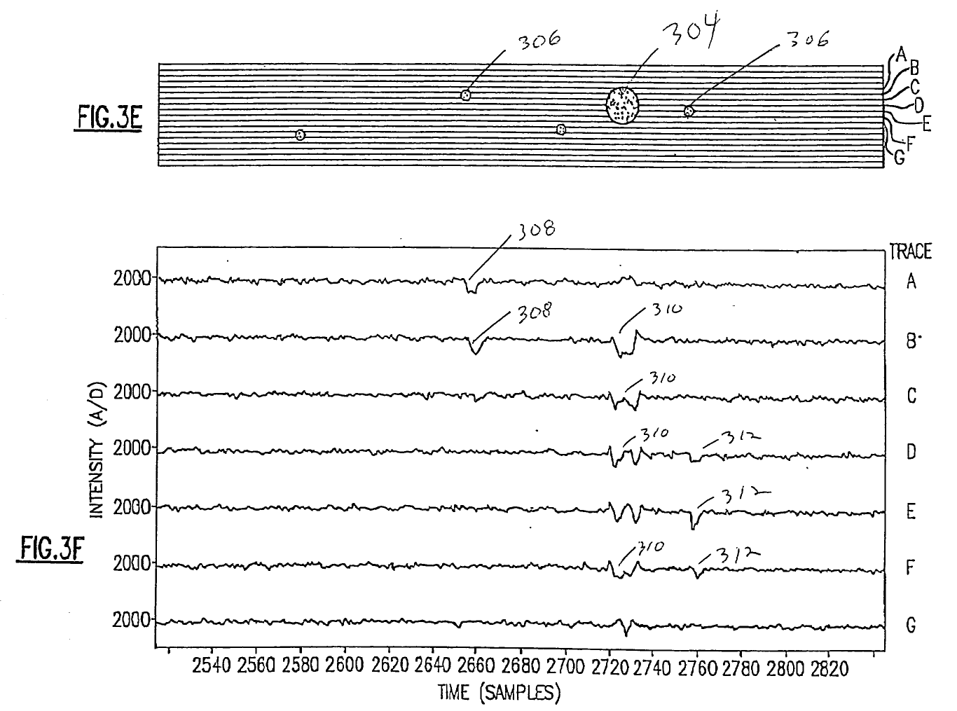

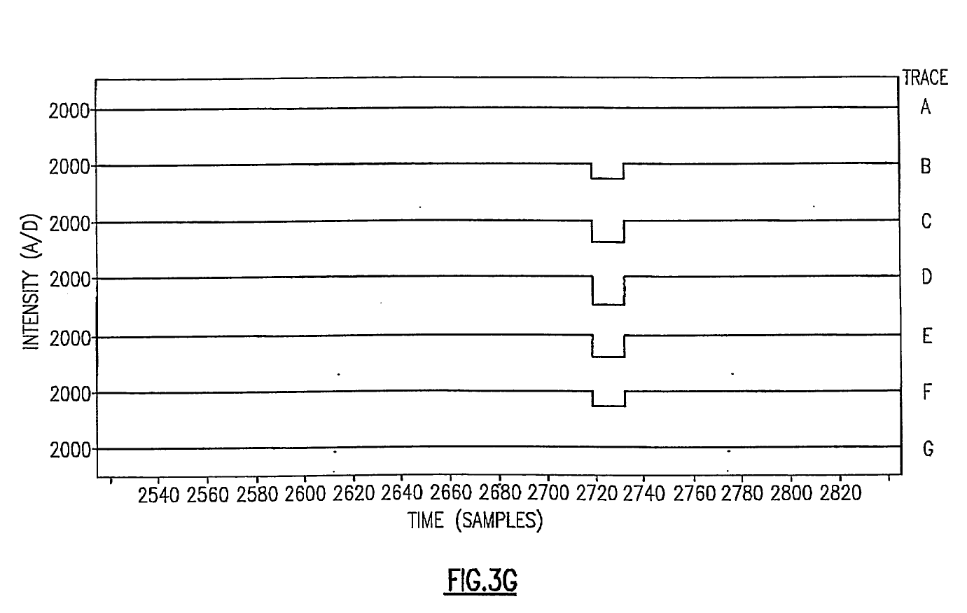

FIG. 3A generally shows an example of the use of pixels in representing beads or cells. FIG. 3A more particularly illustrates an enlarged image of a cell, as rendered by different pixels—some white, some black, and some various shades of gray. If the picture of FIG. 3A were reduced and the edges of the pixels smoothed, the obvious visual features of a cell as we remember them through a microscope would be apparent. For the purposes of data sampling to determine whether a cell is present on the surface of a disc, however, the above detail is all that the computer and analysis program requires for recognition purposes. The raw values of return light from the surface of the cell and the disc are translated into digital values and processed by software as described in further detail herein below.

With reference now to FIG. 3B, there is presented an isolated pixilated image of the cell of FIG. 3A and a related graphical illustration that shows two detected analog signals corresponding to the imaged cell. The cell sits across several tracks on a bio-disc. Graph 301 is a pixelized image that shows the location of the cell on the tracks. The darkened area bounded by the four lines is the pixelized image of the cell. The Y-axis of Graph 301 represents the tracks on the disc (counting from inside edge to the outside edge of the disc). As shown, the cell is positioned near the area of track 590. The X-axis of Graph 301 represents the samples taken along the sampling time-line. As shown, the cell diameter was sampled 80 times from the left to the right which, as indicated, is from sample number 21,720 to sample number 21,800.

Graph 302 depicts two representative corresponding analog signals generated by the beam after its interaction with the same bio-disc. The Y-axis is a scale of the intensity of light detected (in voltage). The X-axis matches the sampling time-line X-axis in Graph 301. The two graph lines in Graph 302 represent the detected light intensity along the two tracks that run through the area of the cell. As shown, the two graph lines in Graph 302 exhibit “dips” in the area that correspond to the location of the cell in Graph 301. Notice how the pixelized representation of the cell in Graph 301 corresponds to the lower detected light intensity as well. More specifically, the darker pixels of the cell correspond to the dips in light intensity detected. FIG. 3B also illustrates a relationship between the sampling rate and the pixelized image of the cell. The higher the sampling rate, the smaller the cell or bead area covered by a single pixel. Thus a higher sampling rate yields an image of higher resolution.

It is not necessary to sample a bead or cell 100 times to determine whether it is a bead based on its size and shape. The sampling rate determines the number of times a digitized signal is taken from an analog signal. Pixelization makes it possible to lower the sampling rate, or to vary the sampling rate, thereby increasing the speed at which sampling and identification can be made of investigational features.

One of the more challenging issues associated with the sampling of bead fields and other investigational features on the optical bio-disc platform is the issue of data manipulation and transfer at high sampling rates. Prior art schemes recognized bead patterns and fields by utilizing mathematical transform functions on images obtained by high sampling rates. Transferring the bulky high resolution data and performing mathematical recognition required expensive system resources in both hardware and software. Sampling at high rates also slows down the overall assay analysis process. One of the methods of the present invention reduces the need for high sampling rates and high processing power. A pixel can be used to identify a bead, cell or other investigational feature. The sampling rate is reduced until a pixel represents the physical dimension of a feature of interest. As sampling rates are lowered, pixels are enlarged. As discussed in further detail below, several parameters can be manipulated until a pixel matches the field dimensions of a bead, cell, signal element, or investigational feature. These parameters include (1) wobble frequency, (2) screen or field resolutions (vertical/horizontal pixel field), (3) sampling rate (pixel size), (4) speed of rotation on the disc (physical size of signal element in one dimension), and (5) signal element size.

As the sampling rate is reduced, the sampled signal becomes less continuous and begins to take on a digital like reproduction. The signal identifies the features at a reduced sampling rate and produces a unique “Digital ID” which is discussed in further detail below. FIG. 3C is an example of a reduced sampling rate and a discretized signal approaching a Digital ID. In FIG. 3D, there is shown the optimized pixelated image field representing the feature of interest as a blackened rectangle. The field of disinterest is rendered white. The blackened rectangle is an optimized representation of a cell that has been sampled with the signal/sample value correlation to pixels as shown. In the lower portion of FIG. 3D, the optimized Digital IDs are shown. One of the implicit benefits of the pixelization methods according to the present invention, is the removal and thus filtering of the signal signatures of smaller features of disinterest that otherwise would require the application of image recognition or traditional techniques. This benefit is illustrated by the left and right flat-line portions of the Digital IDs of FIG. 3D.

This benefit of implicit filtering is further illustrated in FIGS. 3E, 3F, and 3G. FIG. 3E shows a white blood cell (WBC) 304 positioned on the tracks of a bio-disc. The WBC is about 10 μm in diameter. The tracks covered by the WBC 304 are identified as tracks A, B, C, D, E, F, and G. FIG. 3E also illustrates platelets 306 positioned around the WBC 304. FIG. 3F shows a series of resulting analog signals when the return light from the disc is detected. The signals represented in FIG. 3F are derived from an AC coupled and buffered HF signal from the optical drive. Signal traces A and B include small perturbations 308 created by the platelet 306 positioned thereabove in FIG. 3E. Similarly, traces D, E, and F include small perturbations 312 created by the platelet 306 positioned to the right of the WBC 304 in FIG. 3E. In a like manner, traces B, C, D, E, F, and G include perturbations 310 caused by the WBC 304. The small perturbations 308 and 312 from the platelets 306 are undesired and unnecessary when conducting an assay such as a CD-marker assay where counting WBCs is desired. In human blood, on average, there are 40 platelets and 600 red blood cells (RBCs) for every single WBC. Thus, it is of paramount importance when counting WBCs not to miscount by including platelets or RBCs. The techniques of the present methods ensure an accurate count—whether counting WBCs, RBCs, or other investigational features of interest. With reference next to FIG. 3G, there are shown optimized Digital IDs A through G corresponding to the analog signals A to G in FIG. 3F. As shown, Digital IDs A and G are flat-line thus indicating on investigational features of interest. Digital IDs A to F, however, illustrate the presence of a white blood cell. Note that Digital IDs A and B as well as D, E, and F, do not include any remnants of the perturbations 306 or 312 shown in the corresponding traces in FIG. 3F. Thus in this manner, identification of a WBC is achieved with a minimum or optimum sampling rate with the additional benefit of implicit filtering.

Pixelization Examples

Pixelization is a method of the present invention that reduces the need for high sampling rates and high processing power. Pixelization assumes that object recognition can be done at the digitized waveform level instead of at the image level. Thus in succinct terms, instead of using mathematical transform functions on high resolution images to recognize investigational features, the sampling rate can be adjusted so that certain investigational features are recognizable in digital waveform signals. Pixelization according to the present invention eliminates the necessity to sample a bead 80 times to determine whether it has been detected in the signal. Instead, the goal of pixelization is to lower sampling rate so that a single pixel (i.e. one sampling point) can be used to identify a bead, cell, or other signal element of interest on the bio-disc. More specifically, the sampling rate is reduced until a pixel represents the physical dimension of the object under investigation.

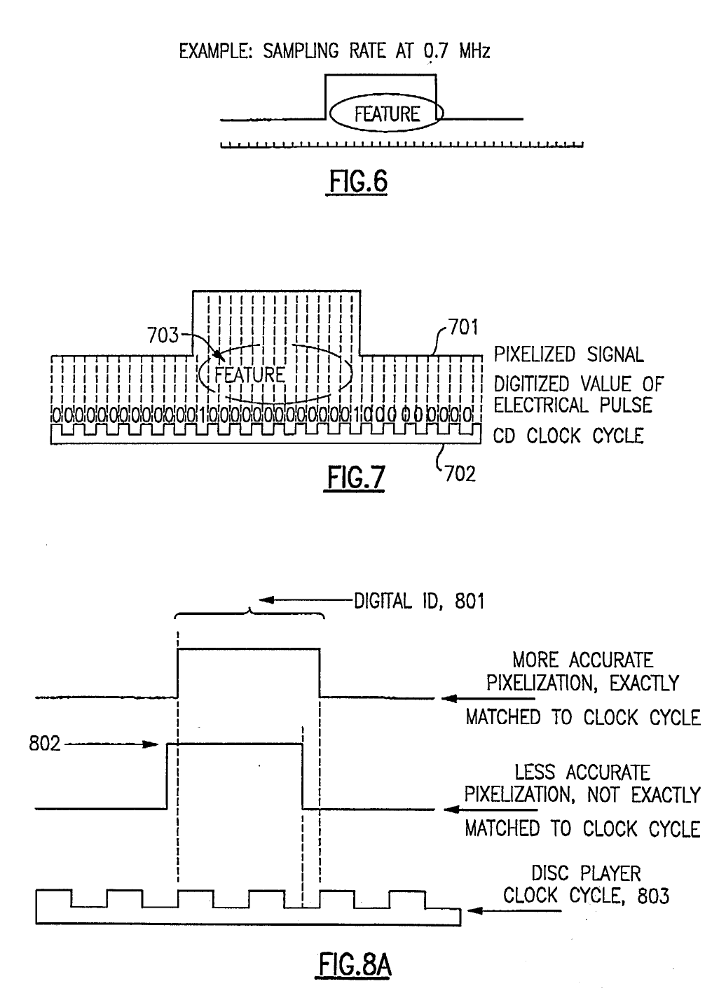

FIGS. 4, 5, and 6 are next discussed to further illustrate pixelization. FIG. 4 illustrates an investigational feature on disc. This investigational feature could be a cell, a bead, a non-bead reporter, or any other signal element of interest. The sampling rate used is 8 MHz and the data points (represented by the black dots) from the sampling produce a line that reflects the light intensity detected over the size of the investigational feature. If such a line pattern were to appear, it would be possible to recognize that the pattern corresponds to an investigational feature since places without investigational feature are represented by a flat line. FIG. 5 illustrates the resulting line formed by data points sampled at 1 MHz. The line formed by the now sparsely spaced black dots is stepped, forming a square-wave pattern. Yet this pattern might still be used to characterize the investigational feature on the disc. If we further lower the sampling rate to 0.7 MHz, then the black dots (data points) would form a single pulse in the line as illustrated in FIG. 6. This is sufficient for recognition because this still represents a unique and identifiable signal change caused by the investigational feature. Thus the lower bound of the sampling rate is a rate that generates a pulse matching the size of the investigational feature or that provides a unique and identifiable signal representing the investigational feature, regardless of the size. The pulse as shown in the 0.7 MHz example of FIG. 6, is called the “Digital ID” for that investigational feature. Furthermore, because this pulse is ultimately translated into a pixel, it is also called a “Pixelated Feature”. Pixelization makes it possible to lower the sampling rate, or to vary the sampling rate, thereby increasing the speed at which sampling and identification can be made of investigational features on the bio-disc. For a bio-disc containing several types of investigational features, a table of sampling rates for different types of investigational features can be constructed. Thus the sampling can be run in accordance with the unique sampling rate of each type of investigational feature to be identified and counted.

One advantage of recognizing investigational features at the signal level is the ability to filter out all other elements on the disc and focus on the type of investigational features of interest with relatively low cost in both hardware and software. As discussed above, once the desired sampling rate for a type of investigational feature is obtained, the sampling process can automatically filter out all other objects on the disc. Only the features of interest will show up in the sampled signal.

Signal Synchronization

After the investigational feature or signal element to be measured is pixelized, the Digital ID can be easily reproduced into a pulse in the form of data channel bits. The pixelization can be reproduced to provide a digital signal that represents an integer multiple of an Optical Disc Clock Cycle as illustrated in FIG. 7. As shown in FIG. 7, there is a digitized value (“0” or “1”) of the pulse (line 701) for every cycle of the CD clock cycle (702). The two vertical edges of the Digital ID on the pulse for investigational feature 703 have the value of 1 at the corresponding CD clock cycle. Because the pulse closely matches the clock cycle, the pulse can be sliced and sampled directly into an optical disc decoding circuit. The Channel Bit Data signal can then be transferred to a storage medium such a hard drive and the number of features detected can then be determined.

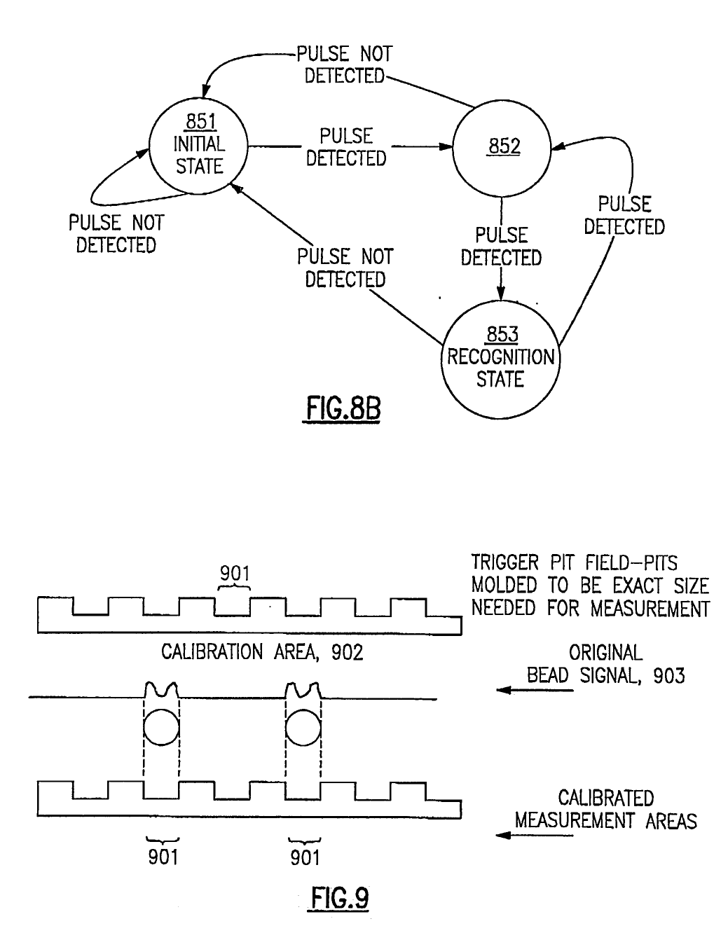

The closer the design of the pixelization to an integer multiple of a clock cycle pulse, the more accurate representation the reproduction will represent. This relationship is graphically illustrated in FIG. 8A. Digital ID 801 substantially matches the optical disc player clock cycle 803, thus providing a more accurate fit. Digital ID 802 is less accurate because it does not substantially match the optical disc player clock cycle 803.

Once the synchronized sampled signals are recorded onto the hard drive, the recognition process can begin on the stored data. The process consists of using an algorithm that has a logical state map designed for each type of investigational feature. An example state map is illustrated in FIG. 8B. In logical state map of FIG. 8B, we start with initial state 851. This map is an example designed to recognize an example type of beads, where each bead is the size of two tracks on the optical bio-disc. The goal of recognition is to find consecutive tracks with pulses representing a bead. The process starts with state 851 and moves along a track. When a pulse (i.e. Digital ID) of a bead is detected, we move to state 852 and move to look for another pulse in the next track. If such a pulse is found, we move to state 853, which is the recognition state where we record the recognition of the bead. If a pulse is found after state 853, we go back to state 852 where we await for the second pulse to show up. If no pulse is found after state 853, we revert to initial state 851. Going back to state 852, if no pulse is found thereafter in the next track, we revert back to initial state 851 and continue to look for a first pulse. Thus, the example of FIGS. 8A and 8B shows how we can design a logical state transition for the recognition algorithm based on the expected size of the target investigational feature. The number of states and their transitions will vary depending on how many tracks of pulses constitute a feature.

Adjusting Sampling Rate

Additional embodiments of the invention are directed at creating bio-discs that can accommodate a special sampling rate for a given type of object under analysis. In one embodiment of this aspect of the present invention, one feature of the bio-disc that specifies the sampling rate is called a Trigger Pit Field. Trigger Pit Fields are pit fields that are specially mastered on optical discs. They are used to calibrate the optical bio-disc player to later recognize investigational features of a specific size. The area on the disc containing a Trigger Pit Field is called the Calibration Area. As shown by the example in FIG. 9, pit 901 is molded to be the size of the bead signal 903 in Calibration Area 902 on the optical bio-disc. Thus a bio-disc player that reads through this pit field will be able to generate a sampling rate that is closely matched to the size of investigational features that are to be detected.

In the CD-R optical bio-disc embodiment of the present invention, the wobble groove technology of the CD-R can be used to adjust the sampling rate. The wobble groove can be pressed in accordance with the type of investigational feature that is to be studied. The spacing of the grooves can encode a sampling rate that enables pixelization of an investigational feature. In another embodiment, grooves encoding different sampling rates are pressed onto different parts of the CD-R disc so that the multiple sampling rates can be used on a single disc that has multiple types of investigational features. Each section of the disc that contains grooves encoding a unique sampling rate can be read ahead of time to calibrate the sampling rate before the type of investigational feature is read on the disc. A Zoned Disc, similar to a DVD disc, can also be used to encode multiple sampling rates. Different zones within the disc can encode different sampling rates.

According to the present invention, the use of the pixelization method within a compact disc player utilizes the player Clock Cycle and Channel Bit Rate, which is typically 4.3218 MHz. The channel bits are 0.28 micrometers in length as encoded on the disc, which results in a rotated speed of 1.21 m/sec.

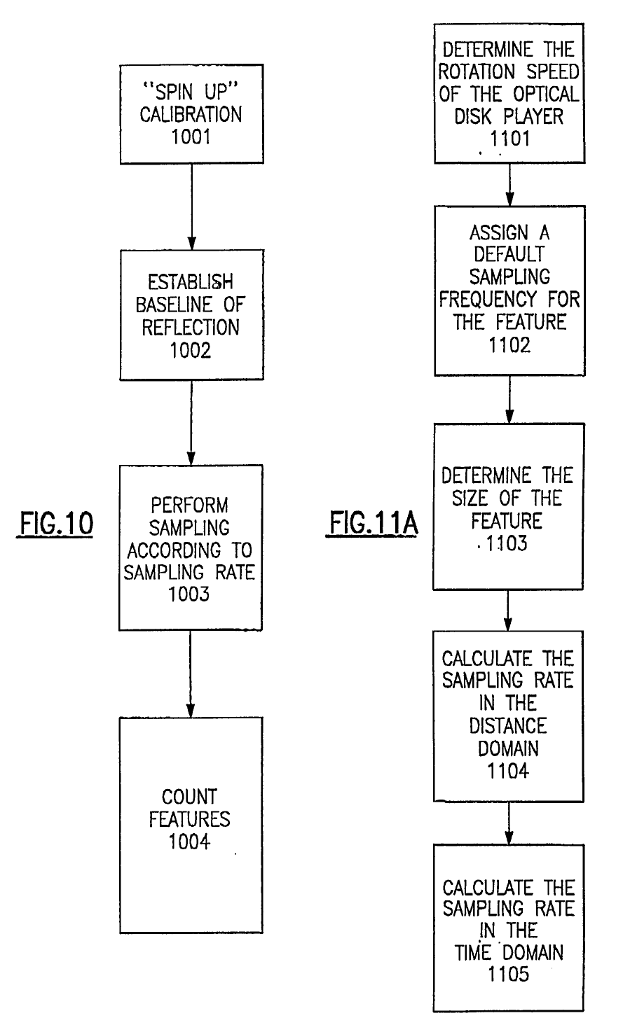

FIG. 10 is a flow chart outlining the method of using the optical drive and disc according to a particular embodiment of the present invention. In step 1001, optical bio-drive according to embodiments of the present invention performs a “spin up” through an initial calibration routine. During this routine, normalization is performed and several tracks are read. This ensures that the optical disc reader clock cycle is in sync with the size of the investigational feature to be studied. Then, in step 1002, a base line light intensity of the reflection from the disc is determined for the purposes of focusing and power control. This step is part of the standard adjustments made by a CD Recordable drive. In this step, signal spikes generated by the investigational features are taken into account in setting the base line. In step 1003, the actual sampling is performed against signal generated from the reflection from the disc and the investigational features on the disc. The sampling is performed against the base line of reflection established in step 1002. The sampling is performed in accordance with the pixelization method, where the sampling rate generates a pixel for each investigational feature. Finally, in step 1004, the features are counted.

According to another embodiment of the present invention, an external sampling card is utilized to sample and count the investigational features on the surface of a bio-disc. The sampling card is set at a sampling rate according to the pixelization method and the calculations presented herein below in the next section. The objective here is to generate a digital signal that is then used to determine the number of investigational features on disc. Another aspect of the invention is software that runs the drive, the sampling card, and displays the results. The software is used to count, for example, red blood cells or beads, when desired.

Calculating the Sampling Rate

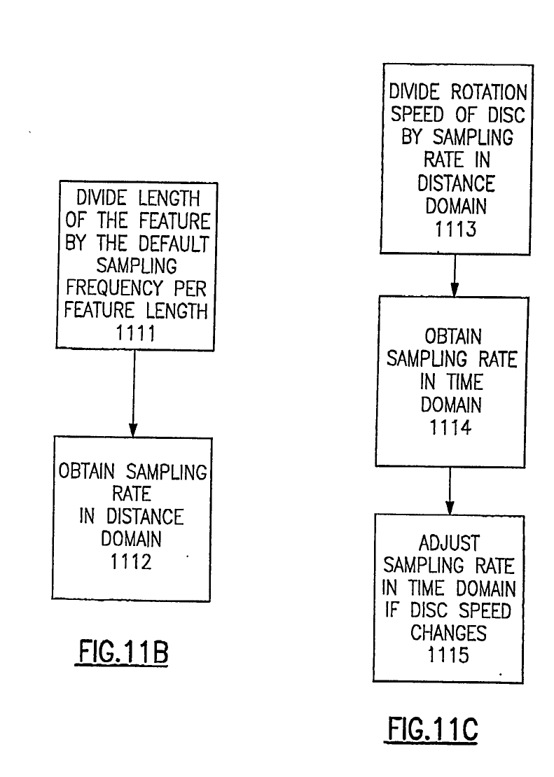

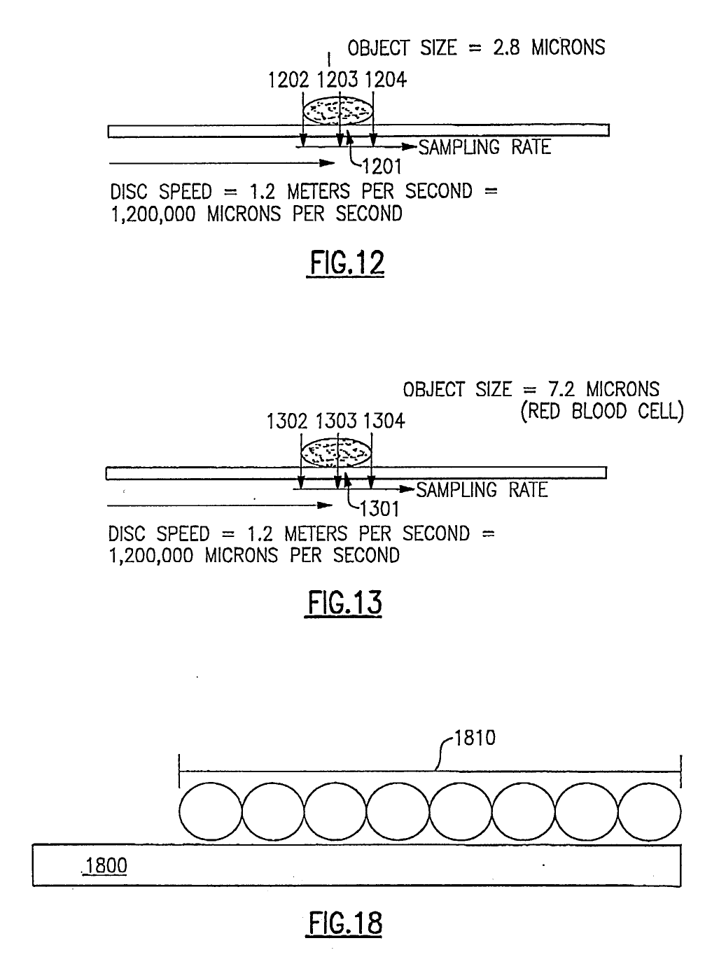

In one embodiment of the present invention, the expected size of an item to be sampled is used to calculate the sampling rate in the pixelization method. FIG. 11A provides a flow chart outlining the method of calculation. In step 1101, the rotation speed of the optical disc player is determined. In the example presented in FIG. 12, we have a CD-R Player at 1× speed rotating the disc at a rate of 1.21 meters per second (given the radial location from center to edge). Then in step 1102, FIG. 11A, a default sampling frequency for the investigational feature is assigned. In this example, we have determined that, in order to sample correctly a bead using pixelization, the sampling rate has to allow for at least two samples to be taken for each bead as the laser passes over the bead. This is shown in FIG. 12, where sampling locations 1202, 1203, 1204 indicate places where sampling is to take place. In one embodiment, twice per the distance covering an investigational feature size is used as a sampling rate. In step 1103, FIG. 11A, the size of the investigational feature is determined. In our specific example, the investigational feature under investigation is a 2.8 micron bead (bead 1201 of FIG. 12). In step 1104, the sampling rate in the distance domain is calculated. FIG. 11B illustrates the detail steps of step 1104. In step 1111, the length of the feature is divided by the default sampling frequency per feature. Going back to our example, since the bead has the length of 2.8 microns and two samples per bead are needed, we divide 2.8 microns by 2. The sampling rate in the distance domain is obtained in step 1112. Thus for our example, the sample is taken at every 1.4 microns as the laser moves along the track.

As shown in FIG. 11A, step 1105 indicates that the sampling rate in the time domain is calculated. Step 1105 is shown in greater detail in FIG. 11C. In step 1113, FIG. 1C, the rotation speed of the disc is divided by the just obtained sampling rate in the distance domain (step 1112 of FIG. 11B). Referring again to our example, the rotation of the disc is 1.21 meters per second or 1,210,000 microns per second. In step 1114, we divide the rotation speed of the disc by the sampling rate in the distance domain to obtain the sampling rate per time unit (seconds) as follows:

1,210,000 μm/second (divided by) 1.4 μm/time=864,286 times/second

which translates to a sampling rate of 864 KHz. If the speed of disc is changed, the sampling rate is adjusted accordingly in step 1115. For our example, if the speed of disc changes to 2×, then our sampling rate is doubled to 1,728 KHz, or 1.7 MHz.

To further illustrate the sampling rate calculation, we consider another example. FIG. 13 contains an example red blood cell, which on average has a size of 6 to 8 microns. The calculation proceeds as described above, tracing the same steps as outlined in FIG. 11A. In step 1101, we have the same optical bio-disc player speed of 1×. In step 1102, we assume the same sampling frequency of twice per investigational feature size. In step 1103, we set the size of the red blood cell at 7.2 micron (see FIG. 13). In step 1104, we calculate the need to sample once every 3.6 microns in distance using the steps of 1111 and 1112 of FIG. 11B. Translating this to the time domain in step 1105, we take steps 1113 and 1114 of FIG. 11C:

1,210,000 μm/second (divided by) 3.6 μm/time=336,111 times/second

which is 336.11 KHz. If the speed of the drive is at 2× or 2.42 m/s, then the sampling rate doubles to 672.22 KHz, per the adjustment made in step 1115 of FIG. 11C. To correct for aliasing and cell variation, the calculated sampling rate may be, for example, doubled for complex cell specimen fields. Other multiplier factors for the calculated sampling rate may be applied as needed depending on the specific assay being conducted.

Event Counting Software

Another embodiment of the present invention is directed to methods and software for event counting. Event counting encompasses the counting of all investigational features, signal elements, or any other countable event patterns that appear in the sampled signals generated by pixelization. One embodiment of the software according to this invention to effect the sampling rate method described above is the BCD™ Capture Studio program produced by Burstein Technologies. BCD, Capture Studio, and BCD Capture Studio are all trademarks of Burstein Technologies, assignee of the present application.

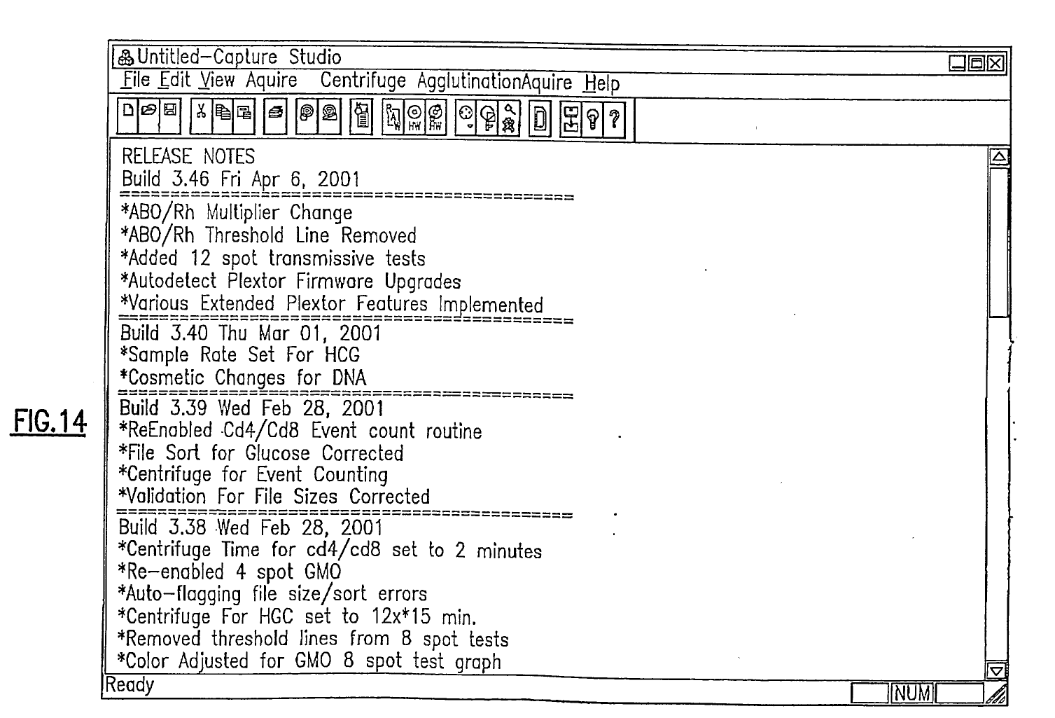

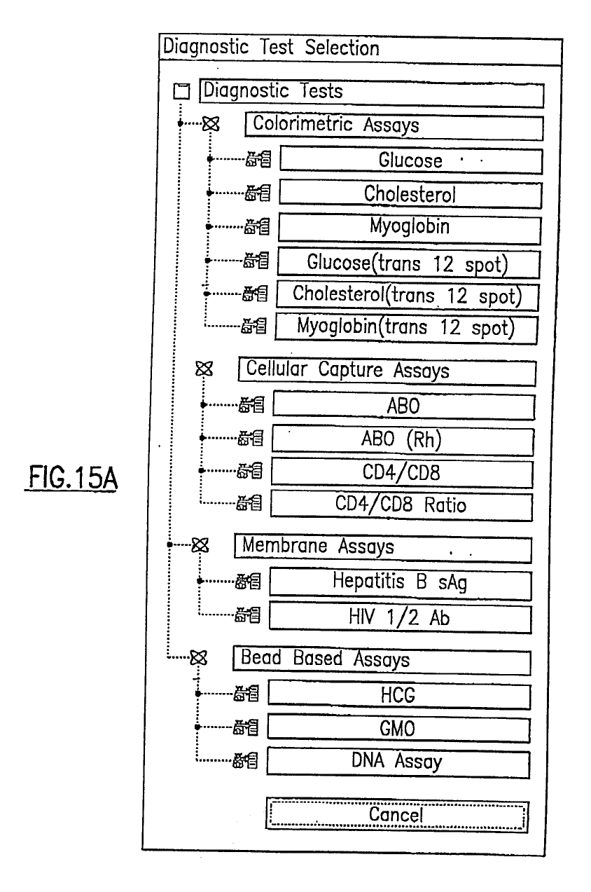

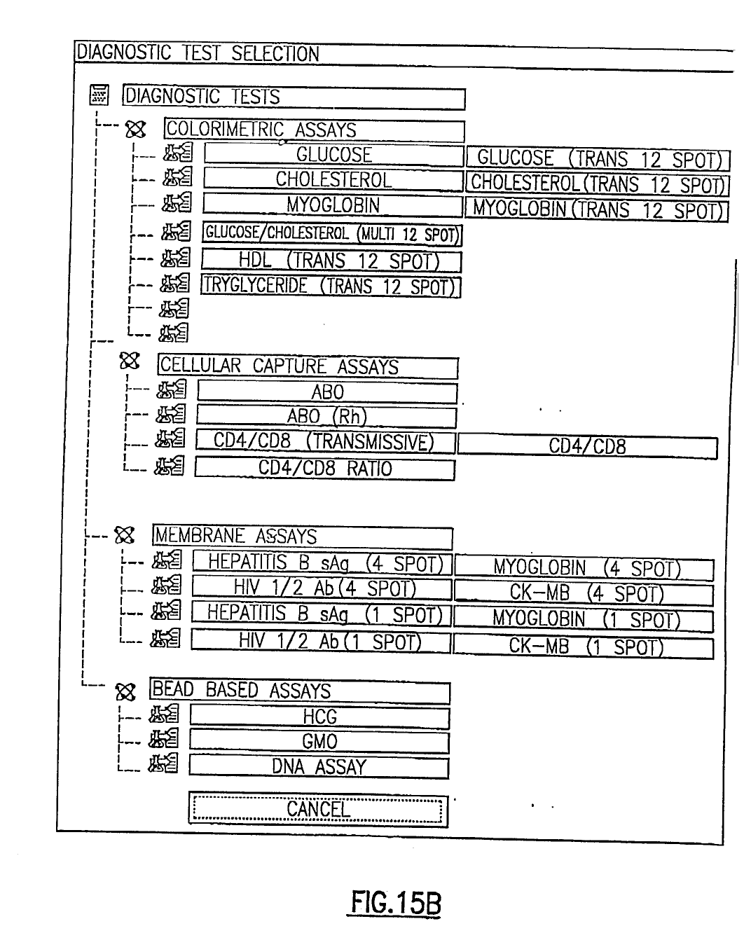

FIG. 14 illustrates certain Release Notes pertaining to the enhancements made to the Capture Studio Program as sampling rates and event counting packages are assembled. FIGS. 15A and 15B are example screen-shot representations each illustrating a diagnostic test selection menu including the different type of assays that can be performed by employing software that uses the methods of the present invention. The selection of test sampling methods in FIGS. 15A and 15B are available through the BCD™ Capture Studio Program. An example of the use of the Event Counting is in the ABO (Rh) Blood Typing Test disclosed in further detail in commonly assigned U.S. Provisional Application No. 60/249,477 entitled “Clinical Diagnostic Optical Disc And Related Methods For Blood Typing, DNA Assays and Molecular Analysis Including Processing Software” filed Nov. 12, 2000; U.S. Provisional Applications 60/353,773 and 60/375,568 each entitled “Methods and Apparatus for Blood Typing with Optical Bio-Discs” and respectively filed on Jan. 31, 2002 and Apr. 25, 2002; and U.S. Provisional Application ______ entitled “Methods and Apparatus for Hematologic Analysis with Optical Bio-Discs” filed May 9 2002, all of which are hereby incorporated by reference in their entireties to thereby provide disclosure as if fully set forth herein.

The Diagnostic Test Selection Screen in FIG. 15B shows the test types currently in use by assignee which utilize aspects of the present invention discussed herein. The Cellular Capture Assays utilize the Event Counting (and its related pixelization and sampling) methods. FIGS. 15A and 15B thus provide examples of the Diagnostic Test Selection which is suitable for use with the present invention.

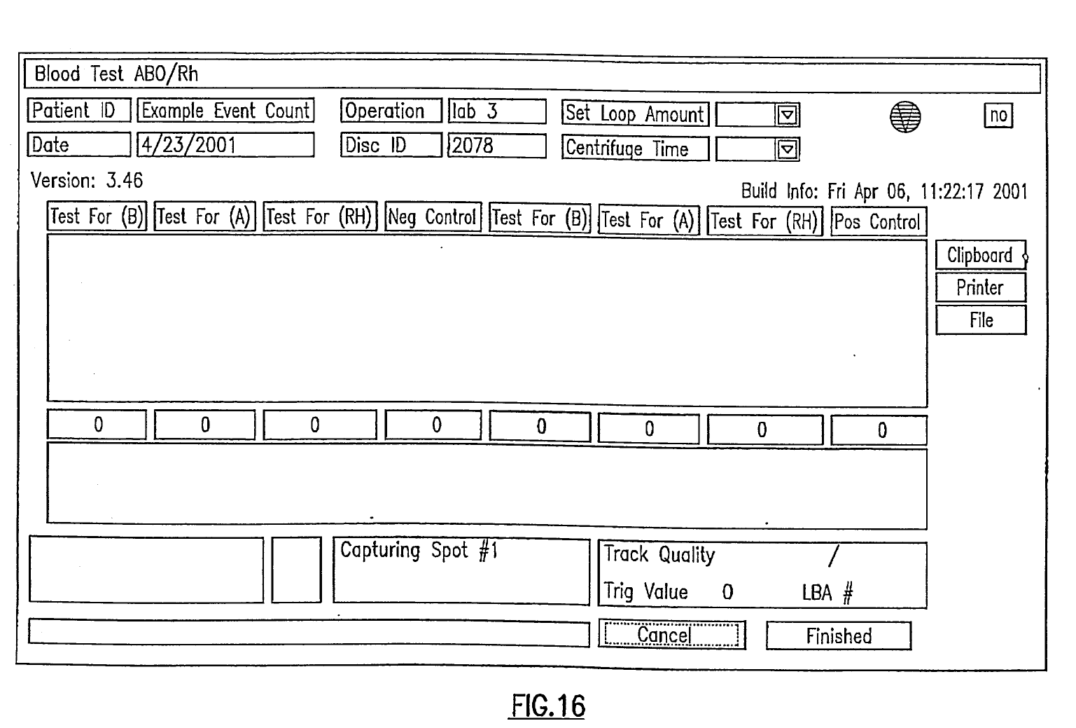

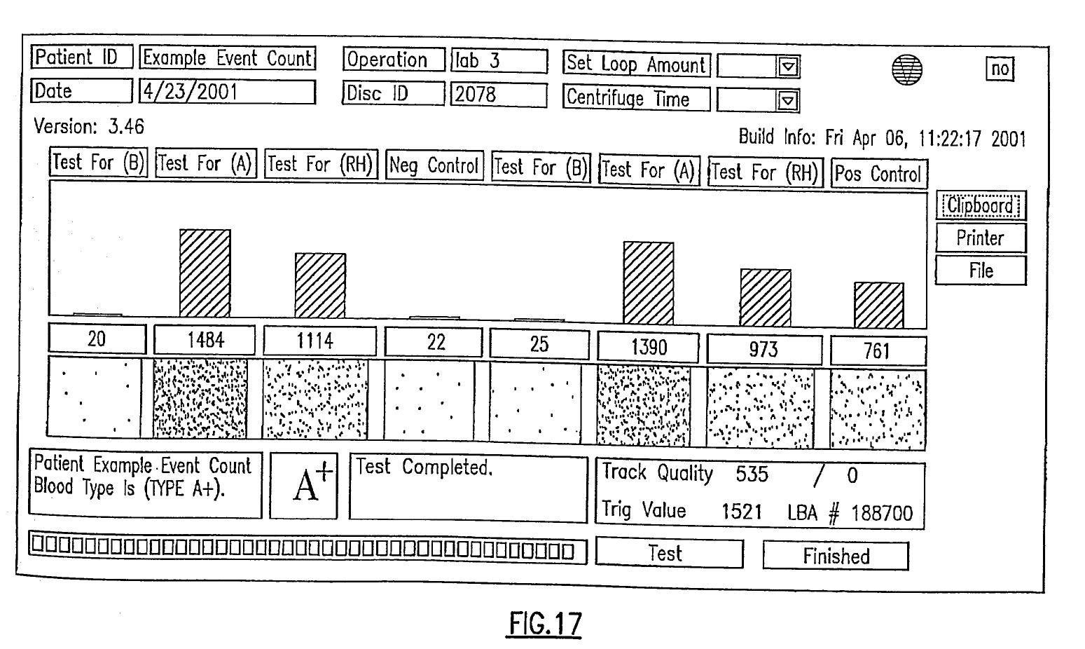

As the test is started, according to one preferred embodiment, the next opening screen shows the areas where the Sampling Event Counting output will be displayed. In the example screen-shot illustrated in FIG. 16, the counting has just begun. When the test is completed, the counts are displayed both numerically and visually as represented in FIG. 17.

Beads as Calibration Mechanism

In the above section entitled “Adjusting the Sampling Rate”, embossed pits equal to the size of a feature were described as a mechanism for calibrating the sampling rate for an optical disc player. As discussed in regard to this sapect of the present invention, the player reads over the pits and calibrates its sampling rate to later recognize investigational features of a specific size according to the principles of Pixelization. FIG. 18 presents another mechanism by which sampling rate calibration can be accomplished. FIG. 18 shows that bead group 1810 is laid on top of disc surface 1800 during the manufacture of the disc. Since beads are relatively small (from between 1 μm and 10 μm, typically) the number of beads used is sufficient for the optical disc player to locate the bead group, read over it and generate a matching sampling rate according to the principles of Pixelization. In one embodiment, the beads are laid down with moldable pit structures of an optical disc. However, the beads could be laid on top of discs of different embodiments such as CD, CD-R, DVD or equivalents with disc surface employing different structures. Regardless of the surface structures on the disc, a plurality of beads is laid down in a designated area on the surface of the disc. When the optical disc player reads over that area, it can calibrate a sampling rate that is a multiple of its clock cycle. The individual beads and/or clumps of beads have the necessary size to represent an optical player clock cycle or multiples thereof. This aspect of the present invention is not necessarily limited to the use of reporter beads ranging in size typically from between 1 μm and 10 μm. With the use of a DVD drive, modified DVD drive, or generally shorter wavelength light sources, bead sizes less than 1 micron may be utilized for calibration or identification. In addition, clumped colloidal gold, other suitable particles, or clumped nano-particles may be similarly employed.

Conclusion

Thus methods and apparatus for effective recognition of cellular matter in laboratory samples using optical equipment is described in conjunction with one or more specific embodiments. While this invention has been described in detail with reference to certain preferred embodiments, it should be appreciated that the present invention is not limited to those precise embodiments. Rather, in view of the present disclosure, which describes the current best mode for practicing the invention, many modifications and variations would present themselves to those of skill in the art without departing from the scope and spirit of this invention. The invention is defined by the claims and their full scope of equivalents.

We claim:

1. A method of identifying an investigational feature imaged by an optical system, said method comprising the steps of:
preparing said investigational feature;
directing an incident beam of electromagnetic radiation at said investigational feature;
allowing said incident beam of electromagnetic radiation to interact with said investigational feature to thereby create a modified beam of electromagnetic radiation that includes characteristics related to said investigational feature;
detecting said modified beam of electromagnetic radiation after interaction with said investigational feature to form a return signal; and
sampling said return signal by reducing the number of samples used to sample said return signal in order to generate a lowest possible number of signal points necessary to identify said investigational feature.

2. The method of claim 1 wherein said step of sampling includes eliminating data points within said return signal, and interpolating inter-point data in order to generate a digital signature to identify said investigational feature.

3. The method of claim 2 wherein said digital signature comprises a pulse of heightened amplitude.

4. The method of claim 3 wherein said step of preparing said investigational feature further comprises:
loading a laboratory sample containing said investigational feature on a rotateable disc; and
rotating said disc in an optical disc drive so that said incident beam is directed toward said disc.

5. The method of claim 4 wherein said laboratory sample comprises more than one investigational feature.

6. The method of claim 4 wherein said pulse is synchronized with the multiples of a clock cycle of said optical disc drive.

7. The method of claim 4 wherein said step of sampling is performed at a rate that is a function of the speed of rotation of said disc.

8. The method of claim 4 wherein said step of sampling is performed at a rate that is a function of the size of said investigational feature.

9. The method of claim 4 wherein said step of sampling is performed at a predetermined sampling rate.

10. The method of claim 9 wherein said predetermined sampling rate is derived by the steps comprising of:
determining the rotation speed of said disc;
assigning a default sampling frequency for said investigational feature;
determining the size of said investigational feature;
calculating an intermediate sampling rate in the distance domain; and
converting said intermediate sampling rate to said predetermined sampling rate in the time domain.

11. The method of claim 9 wherein said predetermined sampling rate is adjusted by having said optical disc drive read wobble grooves on said disc, said grooves having said predetermined sampling rate encoded therein.

12. The method of claim 9 wherein said predetermined sampling rate is adjusted by an external sampling card.

13. The method of claim 9 wherein said predetermined sampling rate is adjusted by having said optical disc drive read a calibration zone on said disc.

14. The method of claim 5 further including the steps of recognizing said investigational features, and counting investigational features.

15. The method of claim 14 wherein said step of recognizing includes designing an algorithm with a logical state transition map that recognizes features spanning consecutive tracks on said disc.

16. An optical system for identifying an investigational feature, said system comprising:
a rotateable disc capable of housing a laboratory sample containing at least one investigational feature;
an optical disc drive including an incident beam of electromagnetic radiation that is directed at said investigational feature, said incident beam being allowed to interact with said investigational feature to thereby create a modified beam of electromagnetic radiation that includes characteristics related to said investigational feature so that a detector detects said modified beam of electromagnetic radiation after interaction with said investigational feature to form a return signal; and
sampling means for sampling said return signal in a manner that reduces the number of samples used to sample said return signal to thereby generate the lowest possible number of signal points necessary to identify said investigational feature.

17. The system of claim 16 wherein said sampling means eliminates data points within said return signal and interpolates inter-point data in order to generate a digital signature to identify said investigational feature.

18. The system of claim 17 wherein said digital signature comprises a pulse of heightened amplitude.

19. The system of claim 18 wherein said pulse is synchronized with the multiples of a clock cycle of said optical disc drive.

20. The system of claim 18 wherein said sampling means samples at a rate that is a function of the speed of rotation of said disc.

21. The system of claim 18 wherein said sampling means samples at a rate that is a function of the size of said investigational feature.

22. The system of claim 18 wherein said sampling means samples at a predetermined sampling rate.

23. The system of claim 22 wherein said predetermined sampling rate is derived by the steps comprised of:
determining the rotation speed of said disc;
assigning a default sampling frequency for said investigational feature;
determining the size of said investigational feature;
calculating an intermediate sampling rate in the distance domain; and
converting said intermediate sampling rate to said predetermined sampling rate in the time domain.

24. The system of claim 22 wherein said predetermined sampling rate is adjusted by having said optical disc drive read wobble grooves on said disc, said grooves having said predetermined sampling rate encoded therein.

25. The system of claim 22 wherein said predetermined sampling rate is adjusted by an external sampling card.

26. The system of claim 22 wherein said predetermined sampling rate is adjusted by having said optical disc drive read a calibration zone on said disc.

27. The system of claim 16 further including software for recognizing and counting a plurality of said investigational features.

28. The system of claim 27 wherein said software includes an algorithm with a logical state transition map that recognizes features spanning consecutive tracks on said disc.

29. The system of claim 28 wherein said software displays a graphical user interface to allow a user to control counting of said investigational features and see results.

30. A method of identifying an investigational object associated with a rotatable disc, said method comprising the steps of:
rotating a respective disc including at least one investigational object;
directing an incident beam of electromagnetic radiation toward said respective disc;
allowing said incident beam of electromagnetic radiation to interact with said investigational object to thereby create a modified beam of electromagnetic radiation that includes characteristics related to said investigational object;
detecting said modified beam of electromagnetic radiation after interaction with said investigational object to form a return signal; and
sampling said return signal in a predetermined manner to thereby identify said investigational object.

31. The method of claim 9 wherein said predetermined sampling rate is adjusted by having said optical disc drive read over a plurality of beads on said disc, said beads encode said predetermined sampling rate.

32. The system of claim 22 wherein said predetermined sampling rate is adjusted by having said optical disc drive read over a plurality of beads on said disc, wherein said beads encode said predetermined sampling rate.
